(19) United States
(12) Patent Application Publication
(10) Pub. No.: US 2013/0161986 A1
(43) Pub. Date: Jun. 27, 2013

(54) VEHICLE SEAT DEVICE

(71) Applicant: RECARO Child Safety GmbH & Co. KG, Marktleugast (DE)

(72) Inventor: Evelyn KOPP, Coburg (DE)

(73) Assignee: RECARO CHILD SAFETY GMBH & CO. KG, Marktleugast (DE)

(21) Appl. No.: 13/713,688

(22) Filed: Dec. 13, 2012

(30) Foreign Application Priority Data
Dec. 21, 2011 (DE) 10 2011 121 858.4
Aug. 30, 2012 (DE) 10 2012 108 054.2

(51) Int. Cl. B60N 2/26

(52) U.S. Cl. CPC B60N 2/265; B60N 2/26
USPC 297/250.1

(57) ABSTRACT

A vehicle seat device, in particular a child seat device, includes at least one head support unit and/or at least one seat cover unit, and also includes at least one shoulder cushion unit.

In order to achieve a high degree of seating comfort, the shoulder cushion unit is connected directly to the head support unit and/or to the seat cover unit.

### CROSS REFERENCE TO RELATED APPLICATIONS

This application is based on and incorporates herein by reference German Patent Application Nos. 10 2011 121 858.4 filed on Dec. 21, 2011 and 10 2012 108 054.2 filed on Aug. 30, 2012.

### BACKGROUND

The invention relates to a vehicle seat device, in particular a child seat device, having at least one head support unit and/or at least one seat cover unit and having at least one shoulder cushion unit, in accordance with the preamble of Claim 1.

For conveying children in motor vehicles, it is a legal requirement in Germany to use a child seat when conveying said children in the case of children below 12 years of age with a height of less than 1.50 m. The child seat is provided for the purpose of increasing the safety of the child in a crash inasmuch as, on the one hand, the children are in a raised sitting position due to the child seat, in which position they can be secured by a safety belt, and, on the other hand, additional impact protection is offered by a shell of the child seat. Another known practice is the additional use of a shoulder cushion unit, which supports the shoulders of the child and forms a bearing surface for the safety belt, ensuring that said belt does not cut into the child's skin.

### SUMMARY

The invention starts from a vehicle seat device, in particular a child seat device, having at least one head support unit and/or at least one seat cover unit and having at least one shoulder cushion unit. The term “vehicle seat device” is intended, in particular, to mean a device which is provided for use in addition to and in interaction with a vehicle seat and/or a child seat. In particular, the vehicle seat device is different from an integral component of the vehicle seat and/or of the child seat, such as a backrest of the vehicle seat and/or of the child seat, and the vehicle seat and/or the child seat is/are preferably also functional if the vehicle seat device is removed. The term “head support unit” is intended, in particular, to mean a unit which is provided, in particular, to ensure lateral support for a head in at least two opposite directions and which, for this purpose, has, in particular, at least two lateral side cushions. The head support unit preferably additionally serves to support the head at the back side thereof and, for this purpose, preferably has a back cushion. In this arrangement, the side cushions and the back cushion can be formed by separate parts, but it is particularly preferable if they are of integral design and form a U shape. The term “integral” is intended, in particular, to mean at least connected by a material bond, e.g. by an adhesive process and/or by some other process which appears appropriate to a person skilled in the art, and/or advantageously molded in one piece, e.g. by production from a common piece of material. Units produced from one piece preferably have a common cover. The term “provided” is intended, in particular, to mean specially configured, designed and/or equipped. The term “seat cover unit” is intended, in particular, to mean a unit which is provided to be stretched over another unit and to at least partially cover the latter. The seat cover unit preferably forms an outer surface. The seat cover unit is preferably manufactured at least in part from a fabric. The term “shoulder cushion unit” is intended, in particular, to mean a unit which is provided to allow support in a shoulder region, in particular support with respect to a safety belt of a vehicle so that said belt does not rest on skin and/or clothing and does not cut into flesh. For this purpose, the shoulder cushion unit preferably has a receiving region for the safety belt. The shoulder cushion unit preferably comprises at least two shoulder cushion elements, which are provided for support and of which in each case at least one shoulder cushion element is arranged at each shoulder. A “shoulder cushion element” is intended, in particular, to mean an at least substantially elongate element which is provided for the purpose of allowing support at the shoulders and shielding a neck from the safety belt. The term “at least substantially elongate” is intended, in particular, to mean an element in which a maximum extent in a longitudinal direction is at least twice, advantageously at least five times, as large and preferably at least ten times as large as a maximum extent in directions perpendicular to the longitudinal direction.

It is proposed that the shoulder cushion unit is connected directly to the head support unit and/or to the seat cover unit. The term “connected directly” is intended, in particular, to mean that the shoulder cushion unit is fastened directly to the head support unit and/or the seat cover unit by means of a fastening unit, wherein, in the case of direct fastening of the shoulder cushion unit and of the head support unit and/or of the seat cover unit to one another, the shoulder cushion unit and the head support unit and/or the seat cover unit can be fastened to a common connecting element, which is a component of the shoulder cushion unit or of the head support unit or of the seat cover unit, e.g. a component of the shoulder cushion unit which connects the two shoulder cushion elements to one another, and/or is embodied integrally with the head support unit and/or the seat cover unit. In particular, direct connection of the shoulder cushion unit and the head support unit and/or seat cover unit is different from connection of the seat cushion unit and of the head support unit and/or of the seat cover unit to different support elements of a support frame and/or different elements of a child seat. In particular, the shoulder cushion unit is fastened to a unit other than a safety belt with the head support unit and/or the seat cover unit. It is possible, in particular, to achieve stable fastening of the shoulder cushion unit and a high degree of seating comfort.

It is furthermore proposed that the shoulder cushion unit is connected detachably to the head support unit and/or to the seat cover unit. The term “connected detachably” is intended, in particular, to mean that the shoulder cushion unit is provided so as to be detached, in an essentially nondestructive manner, from the head support unit and/or the seat cover unit. The shoulder cushion unit is preferably provided so as to be reconnected to a head support unit and/or a seat cover unit after being detached. The term “detached in an essentially nondestructive manner” is intended, in particular, to mean that the shoulder cushion unit retains its functionality after being detached. The shoulder cushion unit preferably has at least one releasable fastening unit, e.g. a hook and loop fastener, a zip fastener or a press stud. It is possible, in particular, to achieve a high degree of flexibility in the use of the shoulder cushion unit.

It is furthermore proposed that the shoulder cushion unit is embodied integrally with the head support unit and/or the seat cover unit. The shoulder cushion unit and the head support unit and/or the seat cover unit are preferably produced from a common piece of woven fabric and/or a common piece of foam, e.g. a common piece of memory foam. It is possible, in particular, to achieve stable fastening of the shoulder cushion unit.

It is furthermore proposed that the head support unit is provided for being detachably integrated into a vehicle seat. The term “for being detachably integrated” is intended, in particular, to mean that the head support unit is connected detachably to the child seat and forms a functional unit with the vehicle seat in an integrated state and that, after detachment of the head support unit, the head support unit and the vehicle seats are in a functional state. It is possible, in particular, to achieve simple exchangeability of the head support unit and simple adaptation of the child seat to different occupants through the exchangeability of the head support unit.

It is furthermore proposed that the head support unit has at least one fastening means, which is provided for fastening the head support unit in the vehicle seat. The fastening means can be formed by a hook and loop fastener, a screw element or a sliding guide, for example. The fastening means can be embodied to be height-adjustable or can fasten the head support unit at a single fixed position in the vehicle seat. In particular, the fastening means is provided for the purpose of fastening the head support unit against a force acting perpendicularly to a backrest surface of the vehicle seat, e.g. an acceleration force occurring in the case of a crash. Secure fastening of the head support unit in the vehicle seat can advantageously be achieved.

It is furthermore proposed that the shoulder cushion unit has a receiving region for a safety belt, said receiving region being closed in at least one plane which extends transversely to a longitudinal extent of the shoulder cushion unit. A “receiving region” is intended, in particular, to mean a region which is provided to receive the safety belt and which accommodates the safety belt along a longitudinal extent of at least one centimeter, advantageously at least five centimeters and preferably at least ten centimeters, guides the safety belt along a main direction of extension of the region and surrounds the safety belt over more than at least one hundred and eighty degrees, preferably over three hundred and sixty degrees. In particular, the receiving region is distinct from a passage opening for a safety belt in a component, through which opening the safety belt can be pulled in order to put it on a person. The receiving region is embodied as a lug, for example. The term “receiving region . . . closed in at least one plane, which extends transversely to a longitudinal extent of the shoulder cushion unit” is intended, in particular, to mean a receiving region which is surrounded by a material of the shoulder cushion unit over 360 degrees in the at least one plane. In particular, the shoulder cushion unit is provided for the purpose of completely shielding a person sitting in the vehicle seat from the safety belt in the receiving region, thus ensuring that the safety belt is free from contact with the skin of the person sitting in the vehicle seat. It is possible, in particular, to achieve reliable guidance of the safety belt on the shoulder cushion unit with a high degree of seating comfort.

It is furthermore proposed that at least one belt guide element is arranged on a receiving region. The term “belt guide element” is intended, in particular, to mean an element which is provided for the purpose of guiding the safety belt along a predetermined trajectory and, in particular, for preventing the safety belt from twisting. The belt guide element can be designed, for example, as a separate element, e.g. a closable ring element, or as a special molding of a shoulder cushion unit region bounding the receiving region. It is possible, in particular, to achieve reliable guidance of the safety belt on the shoulder cushion unit with a high degree of seating comfort.

It is furthermore proposed that the shoulder cushion unit has a closure mechanism, which is provided to nondestructively open the receiving region in order to introduce the safety belt transversely to the longitudinal extent of the shoulder cushion unit. The term “nondestructively open” is intended, in particular, to mean opening of the receiving region in a manner which allows the receiving region subsequently to be closed again while dispensing with external means. The closure mechanism can be formed by a hook and loop fastener, a zip fastener or a press stud, for example. In particular, the closure mechanism is provided for being opened by an end user. The closure mechanism can be provided to allow direct mechanical opening and/or opening by means of a signal via a data circuit which can be connected to an electronic unit of a vehicle, for example by way of a cable or wirelessly. It is possible, in particular, to achieve simple fastening of the safety belt.

It is furthermore proposed that the shoulder cushion unit has at least one spacer element, which is provided for the purpose of holding shoulder cushion elements of the shoulder cushion unit at a predetermined spacing from one another. The spacer element is formed by a strap between the shoulder cushion elements, for example. It is possible, in particular, to achieve snug fitting of the shoulder cushion elements to a person's neck and a high degree of seating comfort.

It is furthermore proposed that the spacer element is of adjustable design. The term “of adjustable design” is intended, in particular, to mean that the spacer element has a means which enables the predetermined spacing to be adjusted. It is possible, in particular, to achieve adaptation of the vehicle seat device to a seated person.

It is furthermore proposed that the spacer element is of elastic design. The term “of elastic design” is intended, in particular, to mean that the spacer element is produced from a material which can be extended elastically in length by at least one percent, advantageously by at least two percent and preferably by at least five percent of its extent. In particular, the spacer element of elastic design is provided for the purpose of allowing a variation in the spacing over a small range. It is possible, in particular, to achieve a high degree of seating comfort.

The vehicle seat device according to the invention is provided, in particular, for use in cars. In principle, the vehicle seat device can also be used in other vehicles, e.g. in trains, buses and aircraft.

### BRIEF DESCRIPTION OF THE DRAWINGS

Further advantages will emerge from the following description of the drawings. In the drawings, illustrative embodiments of the invention are shown. The drawings, the description and the claims contain numerous features in combination. It will also be expedient for a person skilled in the art to consider the features individually and unite them in appropriate further combinations.

FIG. 1 is a schematic view of a vehicle seat device according to the invention,

FIG. 2 is a schematic view of a vehicle seat with a vehicle seat device, and

FIG. 3 is a schematic view of a vehicle seat with an alternative vehicle seat device.

### DETAILED DESCRIPTION

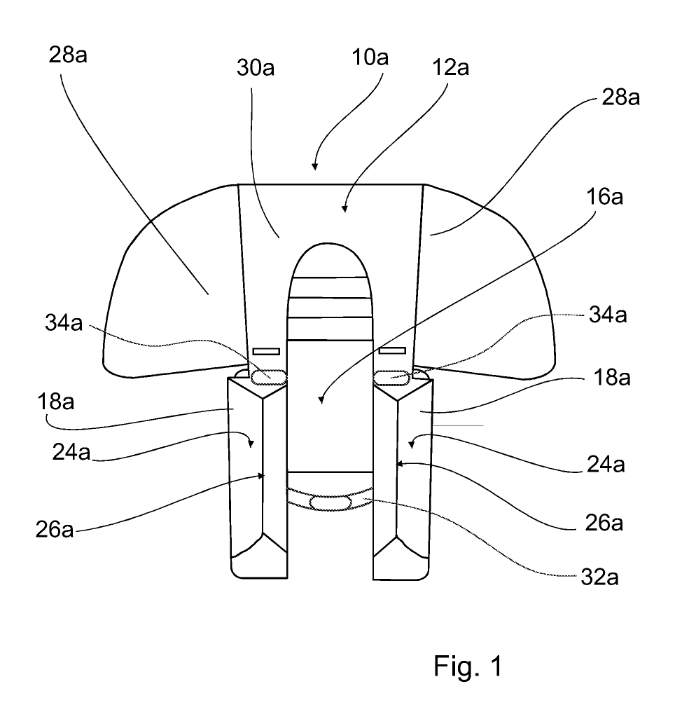

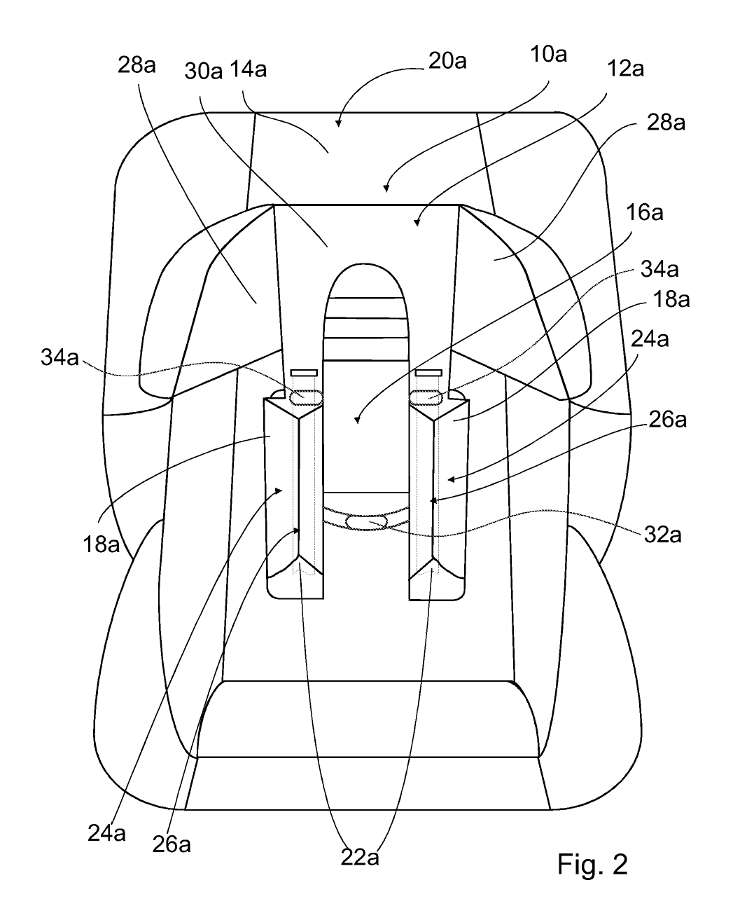

FIG. 1 shows a vehicle seat device 10a formed by a child seat device. The vehicle seat device 10a comprises a head support unit 12a and a shoulder cushion unit 16a. The vehicle seat device 10a is provided for being inserted into a vehicle seat 20a formed by a child seat (FIG. 2). The vehicle seat device 10a furthermore comprises a seat cover unit 14a. The seat cover unit 14a is produced from a woven textile fabric, is stretched over surfaces of the vehicle seat 20a and forms an outer surface of the vehicle seat 20a. To facilitate cleaning of the vehicle seat 20a, the seat cover unit 14a is designed to be removable.

The shoulder cushion unit 16a is connected directly to the head support unit 12a. The shoulder cushion unit 16a is embodied integrally with the head support unit 12a and is produced from a common piece of foam with the latter. As an alternative, the shoulder cushion unit 16a can be connected detachably to the head support unit 12a and/or to the seat cover unit 14a. The shoulder cushion unit 16a has two shoulder cushion elements 18a, which are each provided for arrangement at one shoulder. The shoulder cushion unit 16a has a spacer element 32a which is provided for holding the shoulder cushion elements 18a of the shoulder cushion unit 16a at a predetermined spacing from one another. The spacer element 32a is of elastic design and can extend elastically by five percent in length. The spacer element 32a is designed as an elastic strap, thus allowing variation of the spacing within a small range and enabling pressure on the neck to be avoided. The spacer element 32a is of adjustable design and, for this purpose, has a snap-in buckle, by means of which a component element of the spacer element 32a can be clamped in an immovable manner. A length of the spacing between the shoulder cushion elements 18a can be adjusted and the vehicle seat device 10a adapted to a seated person by pulling through the snap-in buckle. The head support unit 12a has two side cushions 28a, which are arranged on opposite sides of a back cushion 30a and are provided for the purpose of head support.

The head support unit 12a of the vehicle seat device 10a is provided for being detachably integrated into the vehicle seat 20a. The head support unit 12a has a fastening means (not shown), which is arranged on a back side of the head support unit 12a, is formed by a slide rail and is provided for fastening the head support unit 12a in the vehicle seat 20a, interacting for this purpose with a sliding guide mounted on the seat cover unit 14a of the vehicle seat device 10a. By means of the fastening means designed as a slide rail, the head support unit 12a is fastened in a height-adjustable manner in the vehicle seat 20a. As an alternative, it is possible to dispense with a fastening means for the head support unit 12a and for the head support unit 12a to be fastened to a seatbelt 22a by way of the shoulder cushion unit 16a. In this case, the head support unit 12a can be designed to be height-adjustable by means of extendable elements, for example. The head support unit 12a and the shoulder cushion unit 16a of the vehicle seat device 10a can thus be detached from the seat cover unit 14a or the vehicle seat 20a and can, for example, be exchanged.

The shoulder cushion unit 16a has two receiving regions 24a for the safety belt 22a, said receiving regions being closed in a plane which extends transversely to a longitudinal extent of the shoulder cushion unit 16a, of which one receiving region 24a is arranged on each shoulder cushion element 18a. The receiving regions 24a accommodate the safety belt 22a along a length of five centimeters and surround the safety belt 22a over three hundred and sixty degrees. A receiving region 24a is formed by two moldings of the shoulder cushion element 18a which form a lug, respective parts of a hook and loop fastener being arranged on an underside of one molding and on an upper side of the other molding. The hook and loop fastener forms a closure mechanism 26a, which is provided to nondestructively open the receiving region 24a in order to introduce the safety belt 22a transversely to the longitudinal extent of the shoulder cushion unit 16a. In an introduction region, which is formed by an upper region of the receiving region, each receiving region 24a has a belt guide element 34a which is designed as a closable ring element. The safety belt 22a is passed through the belt guide element 34a and then enclosed, with the belt guide element 34a resting snugly against the safety belt 22a and preventing twisting of the safety belt 22a. The vehicle seat 20a furthermore has two slots, through which the safety belt 22a can be passed. Owing to the reception of the safety belt 22a in the receiving region 24a, a person sitting in the vehicle seat 20a is shielded completely from the safety belt 22a by the shoulder cushion unit 16a. The safety belt 22a is thus free from contact with the skin of the person sitting in the vehicle seat 20a.

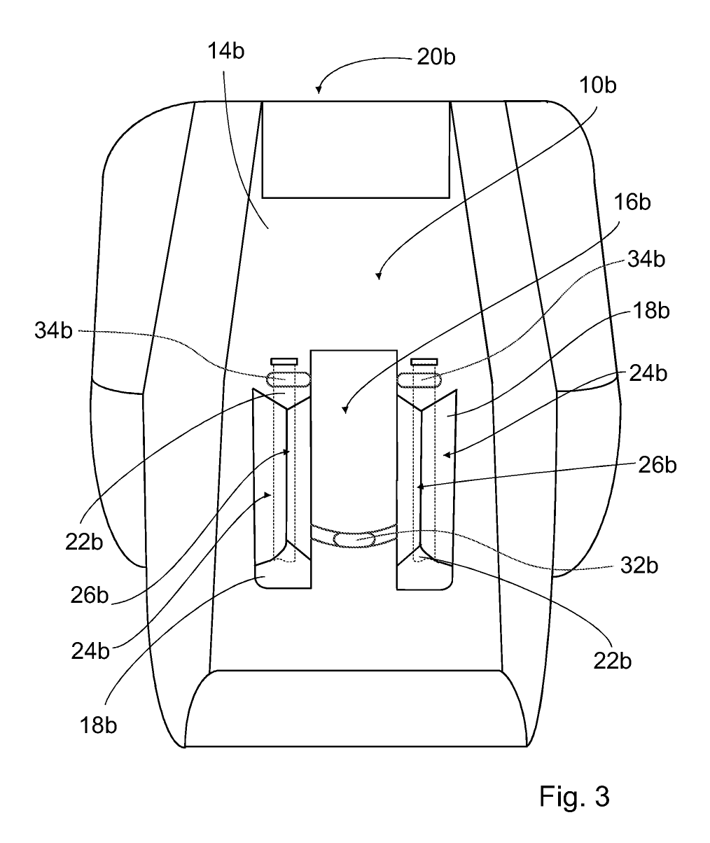

FIG. 3 shows another illustrative embodiment of the invention. To distinguish the illustrative embodiments, the letter “a” in the reference signs for the illustrative embodiment in FIGS. 1 and 2 is replaced by the letter “b” in the reference signs for the illustrative embodiment in FIG. 3. The description of FIG. 3 is restricted essentially to differences with respect to FIGS. 1 and 2. In respect of elements which remain the same, attention is drawn to the description of FIGS. 1 and 2.

In an alternative embodiment, a vehicle seat device 10b comprises a shoulder cushion unit 16b connected directly to a seat cover unit 14b of a vehicle seat 20b. The vehicle seat device 10b comprises moldings of the shoulder cushion unit 16b, which are likewise designed as lugs and form a receiving region 24b for a safety belt 22b. A belt guide element 34b is arranged on an introduction region of the receiving region 24b. An adjustable elastic spacer element 32b is provided for adjusting a spacing between shoulder cushion elements 18b.

1. a vehicle seat device, in particular a child seat device, comprising:
at least one head support unit and/or at least one seat cover unit, and having at least one shoulder cushion unit, wherein
the shoulder cushion unit is connected directly to the head support unit and/or to the seat cover unit.

2. The vehicle seat device according to claim 1, wherein
the shoulder cushion unit is connected detachably to the head support unit and/or to the seat cover unit.

3. The vehicle seat device according to claim 1, wherein
the shoulder cushion unit is embodied integrally with the head support unit and/or the seat cover unit.

4. The vehicle seat device according to claim 1, wherein
the head support unit is provided for being detachably integrated into a vehicle seat.

5. The vehicle seat device according to claim 1, wherein
the head support unit has at least one fastening means which is provided for fastening the head support unit in a vehicle seat.

6. The vehicle seat device according to claim 1, wherein
the shoulder cushion unit has a receiving region for a safety belt, said receiving region being closed in at least one plane which extends transversely to a longitudinal extent of the shoulder cushion unit.

7. The vehicle seat device according to claim 6, wherein
at least one belt guide element is arranged on a receiving region.

8. The vehicle seat device at least according to claim 6, wherein
the shoulder cushion unit has a closure mechanism, which is provided to nondestructively open the receiving region in order to introduce the safety belt transversely to the longitudinal extent of the shoulder cushion unit.

9. The vehicle seat device according to claim 1, wherein
the shoulder cushion unit has at least one spacer element, which is provided for holding shoulder cushion elements of the shoulder cushion unit at a predetermined spacing from one another.

10. The vehicle seat device according to claim 9, wherein
the spacer element is of adjustable design.

11. The vehicle seat device according to claim 9, wherein
the spacer element is of elastic design.

12. A vehicle seat, in particular child seat, having a vehicle seat device according to claim 1.

13. The vehicle seat device according to claim 2, wherein
the head support unit is provided for being detachably integrated into a vehicle seat.

14. The vehicle seat device according to claim 2, wherein
the head support unit has at least one fastening means which is provided for fastening the head support unit in a vehicle seat.

15. The vehicle seat device according to claim 2, wherein
the shoulder cushion unit has a receiving region for a safety belt, said receiving region being closed in at least one plane which extends transversely to a longitudinal extent of the shoulder cushion unit.

16. The vehicle seat device according to claim 3, wherein
the head support unit is provided for being detachably integrated into a vehicle seat.

17. The vehicle seat device according to claim 3, wherein
the head support unit has at least one fastening means which is provided for fastening the head support unit in a vehicle seat.

18. The vehicle seat device according to claim 3, wherein
the shoulder cushion unit has a receiving region for a safety belt, said receiving region being closed in at least one plane which extends transversely to a longitudinal extent of the shoulder cushion unit.

19. The vehicle seat device according to claim 10, wherein
the spacer element is of elastic design.

20. A vehicle seat, in particular child seat, having a vehicle seat device according claim 2.
